(19) United States
(12) Patent Application Publication
(10) Pub. No.: US 2006/0052197 A1
(43) Pub. Date: Mar. 9, 2006

(54) Transmission mechanism

(75) Inventors: Yi-Cheng Tsao, Hsinchu City (TW); Chun-Lung Ho, Hsinchu City (TW); Yu-Feng Chien, Hsinchu City (TW)

Correspondence Address: BRUCE H. TROXELL, SUITE 1404, 5205 LEESBURG PIKE, FALLS CHURCH, VA, 22041, US

(73) Assignee: Lite-On It Corporation

(21) Appl. No.: 11/217,379

(22) Filed: Sep. 2, 2005

(30) Foreign Application Priority Data
Sep. 7, 2004 (TW) 93127024

(51) Int. Cl. F16H 55/30; F16H 55/12

(52) U.S. Cl. 474/158; 474/159

(57) ABSTRACT

A transmission mechanism comprises an idler-shaft, an idler, a belt-pulley, and a first gear. The idler comprises a belt-idler, a gear-idler and a through hole. The idler-shaft couples with the idler through the through hole. The belt-idler has a first face and a second face. The belt-idler is coaxially jointed with the gear-idler on the second face. The first wall located in an edge area surrounding the through hole vertically extends from the first face. The second wall located in a periphery area of the second face horizontally extends from the second face. The first wall and the second wall get used to prevent lubricant splashing on the belt.

### BACKGROUND OF THE INVENTION

(1) Field of the Invention

The present invention generally relates to a transmission mechanism, particularly, to a transmission mechanism of an optical reproducing apparatus for moving a tray.

(2) Description of the Prior Art

Please refer to FIG. 1. FIG. 1 shows a typical optical reproducing apparatus 2. The optical reproducing apparatus 2 comprises a tray 4 and a transmission mechanism 6. The tray 4 used for loading a compact disk is moved back or forth in the optical reproducing apparatus 2 by the transmission mechanism 6, wherein the tray 4 comprises a rack 5 disposed on one side of the tray 4.

Please refer to FIG. 2A and FIG. 2B. FIG. 2A is an explosive diagram of FIG. 1. FIG. 2B shows the detail of the transmission mechanism 6 in FIG. 2A. The transmission mechanism 6 comprises an idler-shaft 609, an idler 604, a belt-pulley 602, and a first gear 606a.

FIG. 3A shows one face of the idler 604 of FIG. 2B; and FIG. 3B shows the other face of the idler 604 of FIG. 2B. The idler 604 comprises a belt-idler 604a, a gear-idler 604b, and a through hole 604h. The belt-idler 604a coaxially joints with the gear-idler 604b. Apparently to those skilled in the art, the belt-idler 604a and the gear-idler 604b could be made separately, then be jointed as the idler 604, or, they could be formed integrally.

As shown in FIG. 2A and FIG. 2B, the transmission mechanism 6 further comprises a motor 8. The belt-pulley 602 is fixed with the motor 8 so as to be spun by the motor 8. The belt-pulley 602 comprises a belt 608 for combining the belt-idler 604a.

The transmission mechanism 6 further comprises a second gear 606b. The second gear 606b meshes with the first gear 606a and the rack 5 shown in FIG. 1. Please returning to FIG. 2B, the belt-pulley 602 spun by the motor 8 drives the belt-idler 604a by the belt 608. The belt-idler 604a spins the gear-idler 604b by the idler 604. The gear-idler 604b drives the first gear 606a driving the second gear 606b. The second gear 606b drives the rack 5 shown in FIG. 1, and further drives the tray 4 to move back or forth.

Please refer to FIG. 3C. FIG. 3C shows the idler-shaft 609 and the idler 604 of FIG. 2B. The idler-shaft 609 couples with the idler 604 through the through hole 604h. In addition, please refer to FIG. 2B, the first gear 606a is coupled with a first gear-shaft 610, and the second gear 606b is coupled with a second gear-shaft 611. For increasing transmission efficiency of the transmission mechanism 6, a lubricant is apply among the idler-shaft 609 and the idler 604, among the first gear 606a and the first gear-shaft 610, and among the second gear 606b and the second gear-shaft 611.

While the transmission mechanism 6 is operating for moving the tray 4 back or forth, the lubricant within would splash on the belt 608 occasionally. This decreases the transmission efficiency of the transmission mechanism 6 because of the decreasing friction force between the belt 608 and the belt-pulley 602, and between the belt 608 and the belt-idler 604a. In the worse situation, the idler 604 may go idle running because of totally losing the friction force with the belt 608. Furthermore, the belt 608 may even separate from the belt-idler 604a and cause the transmission mechanism 6 breakdown.

### SUMMARY OF THE INVENTION

The objective of the present invention is to provide a transmission mechanism used for an optical reproducing apparatus for preventing the lubricant splashing on a belt.

Another objective of the present invention is to provide a transmission mechanism, wherein the combination of the belt and the belt-idler is more reliable.

The present invention relates to a transmission mechanism comprising an idler-shaft, an idler, a belt-pulley, and a first gear. The idler comprises a belt-idler, a gear-idler and a through hole. The idler-shaft couples with the idler through the through hole. The belt-idler has a first face and a second face. The belt-idler is coaxially jointed with the gear-idler on the second face. The first wall located in an edge area surrounding the through hole vertically extends from the first face. The second wall located in a periphery area of the second face horizontally extends from the second face. The first wall and the second wall get used to prevent lubricant splashing on the belt.

The advantage and spirit of the invention may be understood by the following recitations together with the appended drawings.

### BRIEF DESCRIPTION OF THE DRAWINGS

The present invention will now be specified with reference to its preferred embodiment illustrated in the drawings, in which:

FIG. 1 shows a typical optical reproducing apparatus;

FIG. 2A is an explosive diagram of FIG. 1;

FIG. 2B shows the detail of the transmission mechanism of FIG. 2A;

FIG. 3A shows one face of the idler of FIG. 2B;

FIG. 3B shows the other face of the idler of FIG. 2B;

FIG. 3C shows the idler-shaft and the idler of FIG. 2B;

FIG. 4A is an explosive diagram of the optical reproducing apparatus according to the present invention;

FIG. 4B shows details of the transmission mechanism of FIG. 4A;

FIG. 4C shows a combination diagram of the reproducing apparatus of FIG. 4A

FIG. 5A shows one face of the idler of FIG. 4B;

FIG. 5B shows the other face of the idler of FIG. 4B; and

FIG. 5C shows the idler-shaft and the idler of FIG. 4B.

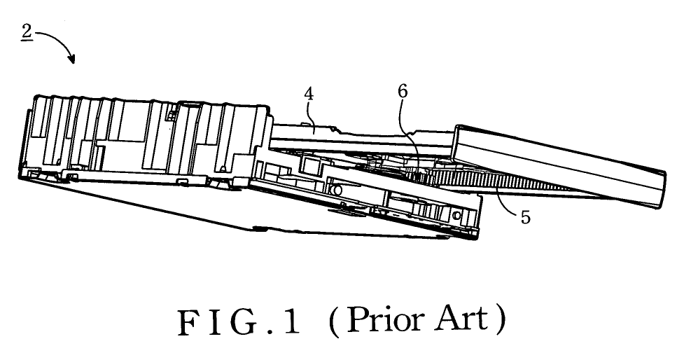

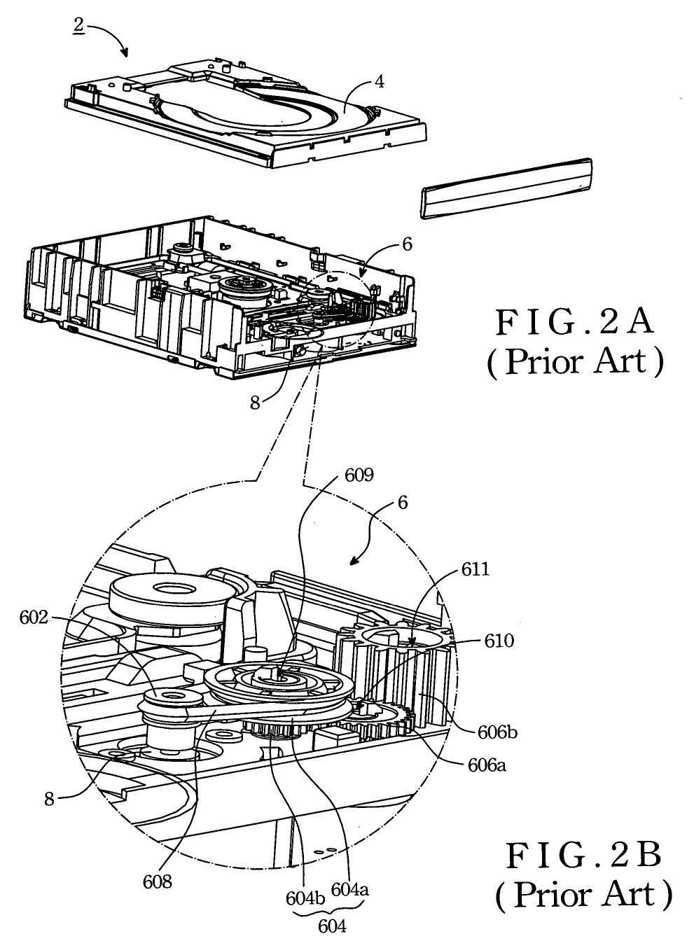

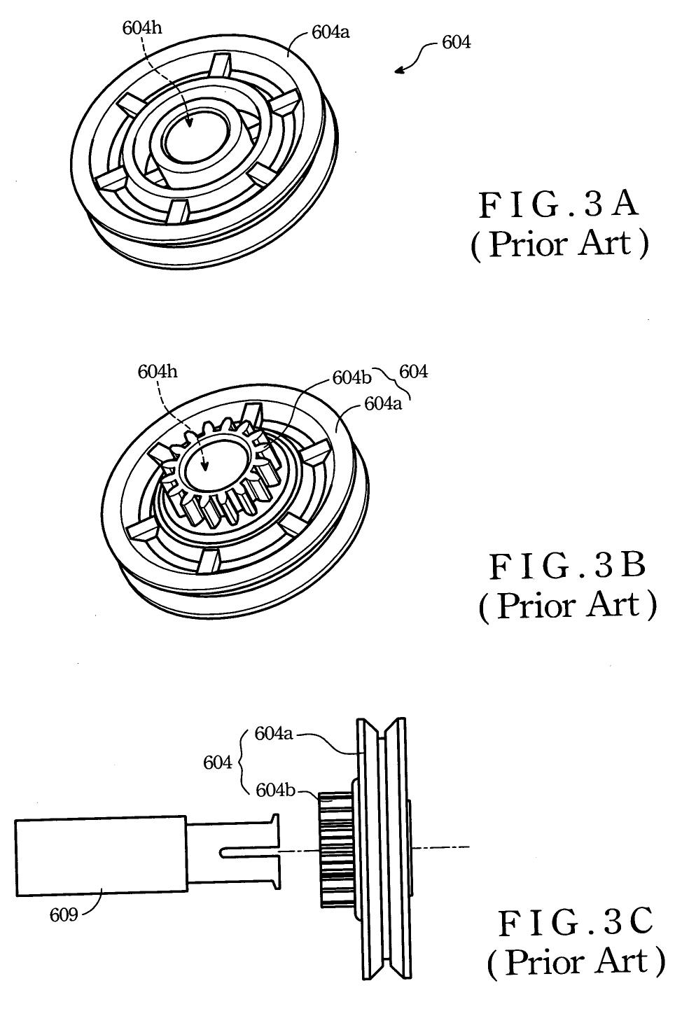

### DESCRIPTION OF THE PREFERRED EMBODIMENT

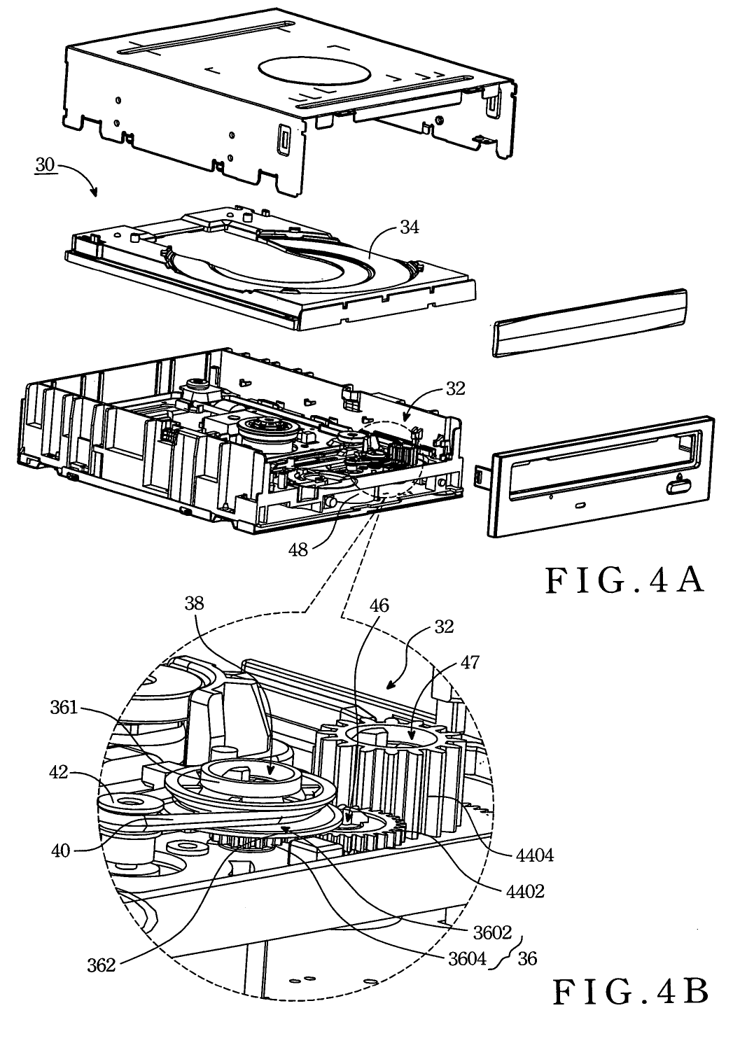

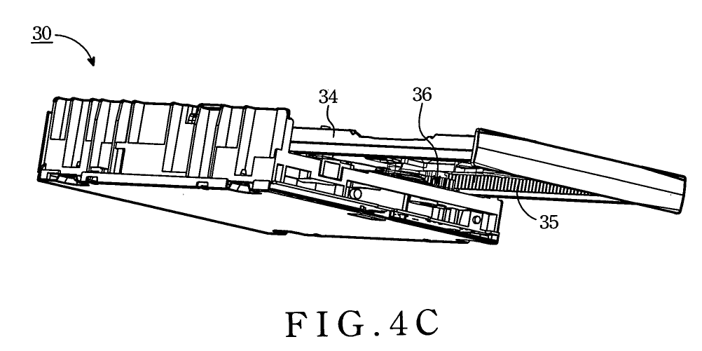

Please refer to FIG. 4A. FIG. 4A is an explosive diagram of the optical reproducing apparatus 30 according to an embodiment of the present invention. The optical reproducing apparatus 30 comprises a transmission mechanism 32 used for moving back or forth a tray 34, wherein the tray 34 comprises a rack 35 (shown in FIG. 4C, which shows a combination diagram of the reproducing apparatus 30 of FIG. 4A) disposed on one side of the tray 34. Please refer to FIG. 4B. FIG. 4B shows details of the transmission mechanism 32 of FIG. 4A. The transmission mechanism 32 comprises an idler-shaft 38, an idler 36, a belt-pulley 42, and a first gear 4402.

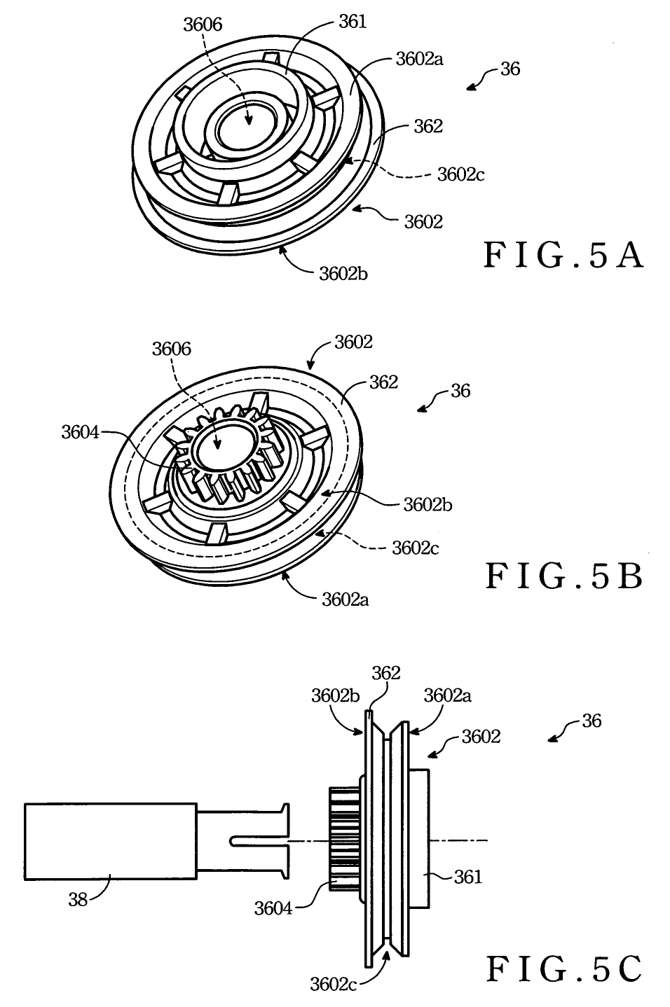

Regarding the idler 36, please refer to FIG. 4B, FIG. 5A, FIG. 5B and FIG. 5C. FIG. 5A shows one face of the idler 36 of FIG. 4B; and FIG. 5B shows the other face of the idler 36 of FIG. 4B. FIG. 5C shows the idler-shaft 38 and the idler 36 of FIG. 4B. The idler 36 comprises a belt-idler 3602, a gear-idler 3604 and a through hole 3606, wherein the belt-idler 3602 has a first face 3602a and a second face 3602b. The belt-idler 3602 is coaxially jointed with the gear-idler 3604 on the second face 3602b. The idler-shaft 38 couples with the idler 36 through the through hole 3606. In one embodiment of the present invention, a first wall 361 located in an edge area surrounding the through hole 3606 vertically extends from the first face 3602a. In another embodiment, A second wall 362 located in a periphery area of the second face 3602b horizontally extends from the second face 3602b.

Please refer to FIG. 4B, the belt-pulley 42 comprises a belt 40 for combining the belt-idler 3602. The belt-idler 3602 has a groove portion 3602c, shown in FIG. 5A˜FIG. 5C, between the first face 3602a and the second face 3602b for receiving the belt 40.

Please refer to FIG. 4B. The transmission mechanism 32 further comprises a second gear 4404. The second gear 4404 meshes with the first gear 4402 and the rack 35 shown in FIG. 4C. While the second gear 4404 is driven by the first gear 4402 to move the rack 35, the tray 34 is moved back or forth in the optical reproducing apparatus 30.

The transmission mechanism 32 of the present invention further comprises a motor 48, shown in FIG. 4A, wherein the belt-pulley 42 is fixed with the motor 48 so as to be spun by the motor 48.

The belt-pulley 42 spun by the motor 48 drives the belt-idler 3602 by the belt 40. The belt-idler 3602 spins the gear-idler 3604 by the idler 36. The gear-idler 3604 drives the first gear 4402 driving the second gear 4404. The second gear 4404 drives the rack 35, and further drives the tray 34 to move back or forth.

The idler-shaft 38 couples with the idler 36 through the through hole 3606. In addition, the first gear 4402 is coupled with a first gear-shaft 46, and the second gear 4404 is coupled with a second gear-shaft 47. For increasing transmission efficiency of the transmission mechanism 32, A lubricant is apply among the idler-shaft 38 and the idler 36, among the first gear 4402 and the first gear-shaft 46 and among the second gear 4404 and the second gear-shaft 47.

While the transmission mechanism 32 is operated for moving the tray 34 back or forth, even in a situation that the lubricant splashes out, the first wall 361 could prevent lubricant splashing on the belt 40. In another embodiment, the second wall 362 also has the function of preventing lubricant from splashing on the belt 40.

As described in the paragraph of Description of the Prior Art, the belt 40 stained with lubricant may decrease transmission efficiency of the transmission mechanism 36, wherein the decrease of the transmission efficiency results form the decreasing friction force and even causes idle running of the belt-idler 3602. Therefore, for improving the above problem, the transmission mechanism 32 of the present invention comprises a first wall 361 and a second wall 362 for preventing the lubricant splashing on the belt 40.

Obviously, the present invention with the first wall 361 and the second wall 362 has much more ability to prevent the lubricant splashing 30 on the belt 40 than prior arts. A transmission mechanism according to the present invention can maintain efficient transmission efficiency and elongate product lifetime. In addition, the second wall 362 further comprises additional advantages. The second wall 362 expands the area of the second face 3602b. This is helpful for preventing the belt 40 from separating or escaping from the belt-idler 3602. While installing the belt 40 on the belt-idler 3602, the second wall 362 can also serve as a substrate, for preventing the belt 40 sliding out of the belt-idler 3602.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

I claim:

1. A transmission mechanism comprising:
an idler-shaft;
an idler, comprising a belt-idler, a gear-idler and a through hole, the idler-shaft coupling with the idler through the through hole, the belt-idler having a first face and a second face, the belt-idler being coaxially jointed with the gear-idler on the second face;
a first gear, meshing with the gear-idler;
a belt-pulley, comprising a belt for combining the belt-idler; and
a first wall, extending from the first face, wherein the first wall is located in an edge area surrounding the through hole.

2. The transmission mechanism according to claim 1, wherein the belt-idler further has a groove portion between the first face and the second face for receiving the belt.

3. The transmission mechanism according to claim 1 further comprising a second wall extending from the second face, wherein the second wall is located in a periphery area of the second face.

4. The transmission mechanism according to claim 3, wherein the first gear coupled with a first gear-shaft, wherein a lubricant is applied among the first gear and the first gear-shaft, and among the idler-shaft and the idler, wherein the first wall and the second wall are used for preventing the lubricant splashing on the belt.

5. The transmission mechanism according to claim 1 further comprises a motor, wherein the belt-pulley is fixed with the motor so as to be spun by the motor.

6. The transmission mechanism according to claim 1 is used for an optical reproducing apparatus, wherein the optical reproducing apparatus comprises a tray having a rack disposed on one side of the tray, the transmission mechanism further comprising a second gear meshing with the first gear and the rack.

7. The transmission mechanism according to claim 1, wherein the first wall is vertically extending from the first face.

8. The transmission mechanism according to claim 2, wherein the second wall is horizontally extending from the second face.

9. A transmission mechanism comprising:
an idler-shaft;
an idler, comprising a belt-idler, a gear-idler and a through hole, the idler-shaft coupling with the idler through the through hole, the belt-idler having a first face and a second face, the belt-idler being coaxially jointed with the gear-idler on the second face;
a first gear, meshing with the gear-idler;
a belt-pulley, comprising a belt for combining the belt-idler;
a first wall, extending from the first face, wherein the first wall is located in an edge area surrounding the through hole; and
a second wall, extending from the second face, wherein the second wall is located in a periphery area of the second face.

10. The transmission mechanism according to claim 9, wherein the belt-idler further has a groove portion between the first face and the second face for receiving the belt.

11. The transmission mechanism according to claim 9, wherein the first gear coupled with a first gear-shaft, wherein a lubricant is applied among the first gear and the first gear-shaft, and among the idler-shaft and the idler, wherein the first wall and the second wall are used for preventing the lubricant splashing on the belt.

12. The transmission mechanism according to claim 9 further comprises a motor, wherein the belt-pulley is fixed with the motor so as to be spun by the motor.

13. The transmission mechanism according to claim 9 is used for an optical reproducing apparatus, wherein the optical reproducing apparatus comprises a tray having a rack disposed on one side of the tray, the transmission mechanism further comprising:
a second gear, meshing with the first gear and the rack.

14. The transmission mechanism according to claim 9, wherein the first wall is vertically extending from the first face.

15. The transmission mechanism according to claim 9, wherein the second wall is horizontally extending from the second face.

16. A transmission mechanism comprising:
an idler-shaft;
an idler, comprising a belt-idler, a gear-idler and a through hole, the idler-shaft coupling with the idler through the through hole, the belt-idler having a first face and a second face, the belt-idler being coaxially jointed with the gear-idler on the second face;
a first gear, meshing with the gear-idler;
a belt-pulley, comprising a belt for combining the belt-idler; and
a second wall, extending from the second face, wherein the second wall is located in a periphery area of the second face.
